(19) United States
(12) Patent Application Publication
(10) Pub. No.: US 2006/0126612 A1
(43) Pub. Date: Jun. 15, 2006

(54) Method of transporting a PCI express packet over an IP packet network

(76) Inventors: Douglas L. Sandy, Chandler, AZ (US); Jeffrey M. Harris, Chandler, AZ (US); Robert C. Tufford, Chandler, AZ (US)

Correspondence Address: MOTOROLA, INC., LAW DEPARTMENT, 1303 E. ALGONQUIN ROAD, SCHAUMBURG, IL, 60196, US

(21) Appl. No.: 10/996,983

(22) Filed: Nov. 23, 2004

(51) Int. Cl. H04L 12/56; H04J 3/16

(52) U.S. Cl. 370/389; 370/466; 370/401

(57) ABSTRACT

In a computer network (100), a method transporting a PCI Express packet (235) from an initiator PCI Express node (202) over an IP packet network (210) to a receiver PCI Express node (204), can include the initiator PCI Express node creating the PCI Express packet and reading a global PCI Express destination address (352) of the PCI Express packet. The initiator PCI Express node can map the global PCI Express destination address to a receiver PCI Express node IP address (242). The PCI Express packet can be encapsulated in an IP packet (236). The IP packet with the encapsulated PCI Express packet can be communicated over an IP packet network (210) to receiver PCI Express node.

### BACKGROUND OF THE INVENTION

The PCI (Peripheral Component Interconnect) Bus has been widely used as a general purpose I/O interconnect standard over the last ten years, but is beginning to hit the limits of its capabilities. Extensions to the PCI standards, such as 64-bit slots and clock speeds of 66 MHz or 100 MHz, are too costly, and just cannot meet the rapidly increasing bandwidth demands in PCs over the next few years. PCI Express has been recently developed to meet this challenge and takes the form of a serial bus architecture.

Internet Protocol (IP) is the world's most popular open-system (nonproprietary) protocol suite because it can be used to communicate across any set of interconnected networks and is equally well suited for LAN and WAN communications. While PCI Express may become the standard for internal PC networks, IP will likely remain the network standard for external networks such as the Internet. The prior art does not provide a means to transport PCI Express packets over the ubiquitous IP network. This has the disadvantage in that PCI Express packets and IP packets must continually be translated between the two networks, thereby increasing costs and slowing network operation.

Accordingly, there is a significant need for an apparatus and method that overcomes the deficiencies of the prior art outlined above.

### BRIEF DESCRIPTION OF THE DRAWINGS

Referring to the drawing:

FIG. 1 depicts a computer network according to one embodiment of the invention;

FIG. 2 depicts a computer network according to another embodiment of the invention;

FIG. 3 depicts a PCI Express packet encapsulated into an IP packet according to an embodiment of the invention;

FIG. 4 illustrates a flow diagram of a method of the invention according to an embodiment of the invention; and

FIG. 5 illustrates a flow diagram of a method of the invention according to another embodiment of the invention.

It will be appreciated that for simplicity and clarity of illustration, elements shown in the drawing have not necessarily been drawn to scale. For example, the dimensions of some of the elements are exaggerated relative to each other. Further, where considered appropriate, reference numerals have been repeated among the Figures to indicate corresponding elements.

### DESCRIPTION OF THE PREFERRED EMBODIMENTS

In the following detailed description of exemplary embodiments of the invention, reference is made to the accompanying drawings, which illustrate specific exemplary embodiments in which the invention may be practiced. These embodiments are described in sufficient detail to enable those skilled in the art to practice the invention, but other embodiments may be utilized and logical, mechanical, electrical and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known circuits, structures and techniques have not been shown in detail in order not to obscure the invention.

For clarity of explanation, the embodiments of the present invention are presented, in part, as comprising individual functional blocks. The functions represented by these blocks may be provided through the use of either shared or dedicated hardware, including, but not limited to, hardware capable of executing software. The present invention is not limited to implementation by any particular set of elements, and the description herein is merely representational of one embodiment.

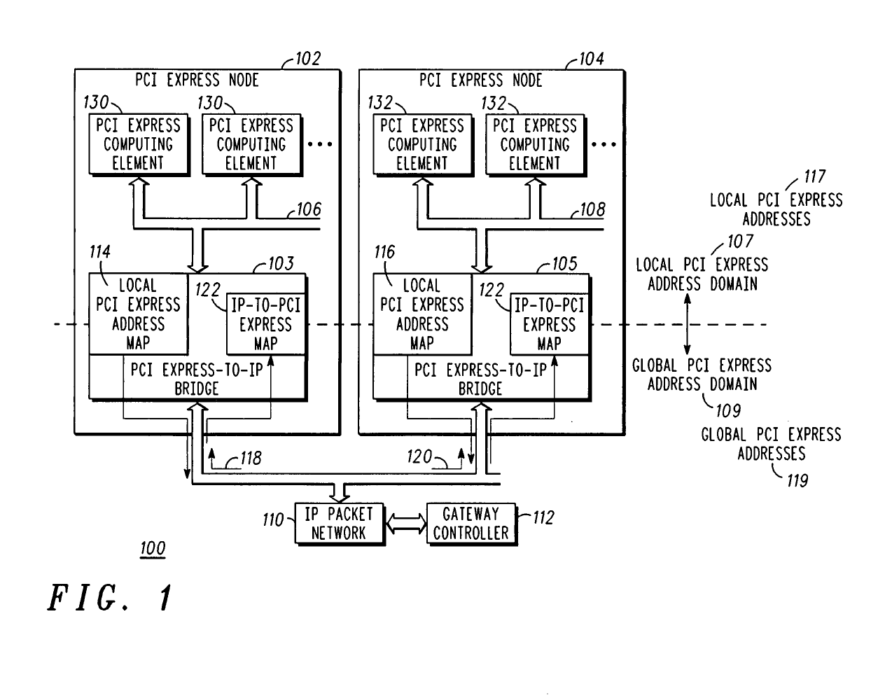

FIG. 1 depicts a computer network 100 according to one embodiment of the invention. Computer network 100 can include an IP packet network 110 coupled to a gateway controller 112. IP packet network 110 can operate using a suite of communication protocols known in the art, of which the two best known are the Transmission Control Protocol (TCP) and the Internet Protocol (IP). The Internet protocol suite not only includes lower-layer protocols (such as TCP and IP), but also can specify common applications such as electronic mail, terminal emulation, and file transfer.

The Internet Protocol is a network-layer protocol that contains addressing information and some control information that enables packets to be routed. IP is the primary network-layer protocol in the Internet protocol suite. Along with the Transmission Control Protocol, IP represents the heart of the Internet protocols. IP has two primary responsibilities: providing connectionless, best-effort delivery of packets through an internetwork of nodes; and providing fragmentation and reassembly of packets to support data links with different maximum-transmission unit (MTU) sizes.

Gateway controller 112 can be used to allow individual nodes coupled to IP packet network 110 to extract their configurations. In other words, individual nodes coupled to IP packet network 110 can extract their configuration from gateway controller 112. In an example, gateway controller 112 may not have any information on an individual node coupled to IP packet network 110 until that individual node requests information. An example of gateway controller 112 can be a Dynamic Host Configuration Protocol (DHCP) server. DHCP is an Internet protocol for automating the configuration of computers that use TCP/IP. DHCP can be used to automatically assign IP addresses, to deliver TCP/IP stack configuration parameters such as the subnet mask and default router, and to provide other configuration information for example addresses for printer, time and news servers.

By way of background, Peripheral Component Interconnect (PCI) was developed in the early 1990's as a general I/O architecture to transfer data and instructions faster than the ISA architecture of the time. PCI has gone through several improvements since that time, with the latest proposal being PCI Express. In a nutshell, PCI Express is a replacement of the PCI and PCI-X bus specification to provide platforms with much greater performance, while using a much lower pin count (Note: PCI arid PC-X are parallel bus architectures, PCI Express is a serial bus architecture). A complete discussion of PCI Express is beyond the scope of this specification, but a thorough background and description can be found in the following books which are incorporated herein by reference: Introduction to PCI Express, A Hardware and Software Developer's Guide, by Adam Wilen, Justin Schade, Ron Thornburg; The Complete PCI Express Reference, Design Insights for Hardware and Software Developers, by Edward Solari and Brad Congdon; and PCI Express System Architecture, by Ravi Budruk, Don Anderson, Tom Shanley; all of which are available at www.amazon.com. In addition, the PCI Express specification is managed and disseminated through the Special Interest Group (SIG) for PCI found at www.pcisig.com.

Computer network 100 can include any number of PCI Express nodes 102, 104 coupled to IP packet network 110. By way of example, PCI Express node 102 can be any board, chassis, network or system that includes one or more PCI Express computing elements 130 coupled by a PCI Express network 106. PCI Express computing element 130 can include, but is not limited to, a processor, memory device, storage device, communication device providing wireline or wireless access, and the like. PCI Express computing element 130 is coupled to communicate on PCI Express network 106 using PCI Express packets. In an embodiment, each PCI Express computing element 130 is coupled to PCI Express network 106. In an embodiment, PCI Express network. 106 is coupled to PCI Express-to-IP bridge 103 which can function to encapsulate and de-encapsulate PCI Express packets in and out of IP packets as explained more fully below.

In an embodiment, computer network 100 can include a local PCI Express address domain 107 comprising a plurality of local PCI Express addresses 117. Local PCI Express addresses 117 are only recognizable and readable within a local PCI Express network such as PCI Express network 106 and can include, for example, one or more memory address spaces. For example, local PCI Express addresses on PCI Express node 102 may only be recognizable and relevant to PCI Express computing elements 130 coupled to PCI Express network 106 on PCI Express node 102 as they reference one or more unique memory address spaces on PCI Express node 102. Also, PCI Express node 104 can have its own set of local PCI Express addresses relevant only to PCI Express computing elements 132 coupled to PCI Express network 108 on PCI Express node 104. As local PCI Express addresses 117 are relevant only in a particular domain, such as PCI Express node 102 or PCI Express node 104, they generally cannot be used to address packets going from one PCI Express node to another PCI Express node.

In an embodiment, computer network 100 can also include global PCI Express address domain 109 comprising a plurality of global PCI Express addresses 119. Global PCI Express addresses 119 are recognizable and relevant on all PCI Express nodes 102, 104 within computer network 100. Global PCI Express addresses 1 19 can be, for example and without limitation, one or more memory address spaces where any PCI Express computing element 130, 132 within computer network 100 has one or more unique memory address spaces. Global PCI Express addresses 119 can be used to specify a destination address for a packet going from a PCI Express computing element on one PCI Express node to another PCI Express computing element on another PCI Express node within computer network 100.

Although global PCI Express addresses 119 can be used to specify a destination address for a packet going from one PCI Express node 102 to another PCI Express node 104, these global PCI Express addresses 119 are not recognizable to IP packet network 110. Therefore, any PCI Express packet addressed from one PCI Express node 102 to another PCI Express node 104 cannot travel over IP packet network 110 by itself.

In an embodiment, PCI Express node 102 can include PCI Express-to-IP bridge 103 coupled to PCI Express network 106 and to IP packet network 110. In an embodiment, PCI Express-to-IP bridge 103 can include any combination of hardware, software, and the like. PCI Express-to-IP bridge 103 can function to encapsulate a PCI Express packet into an IP packet for transport over IP packet network. PCI Express-to-IP bridge 103 can also function to de-encapsulate a PCI Express packet from an IP packet so the PCI Express packet can be communicated over PCI Express network 106.

PCI Express node 104 can also include any number of PCI Express computing elements 132 coupled by PCI Express network 108. PCI Express node 104 can also include PCI Express-to-IP bridge 105 that functions to encapsulate and de-encapsulate a PCI Express packet in a manner analogous to that described with reference to PCI Express-to-IP bridge 103 in PCI Express node 102.

An exemplary embodiment of a method of initializing computer network 100 is depicted in FIG. 1. In an embodiment, upon power-up or boot-up of computer network 100, PCI Express node 102 determines a local PCI Express address map 114, which can be for example a list of all local PCI Express addresses of each of the PCI Express computing elements 130 on PCI Express node 102. In an embodiment, local PCI Express address map 114 can be a list of the local PCI Express addresses of all PCI Express computing elements 130 capable of sending, receiving, and the like, a PCI Express packet. The same procedure can be repeated for PCI Express node 104 which can generate local PCI Express address map 116 in an analogous manner.

In an embodiment, also upon power-up or boot-up of computer network 100, each PCI Express node 102, 104 can request and receive from gateway controller 112, an IP address 118, 120. For example, PCI Express node 102 can request IP address 118 and PCI Express node 104 can request IP address 120. Each IP address for each PCI Express node in computer network 100 can be unique so as to uniquely identify each PCI Express node on IP packet network 110. As is known in the art, an IP address can be used to uniquely identify a node that is making use of IP packet network 110. The IP address can be used by the IP packet network 110 to direct data to each PCI Express node 102, 104. In one embodiment, it can be the task of gateway controller 112 to get a functional and unique IP number to each PCI Express node 102, 104 that make use of IP packet network 110. In another embodiment, gateway controller 112 does not assign IP addresses as IP addresses for each of PCI Express nodes 102, 104 can be static or determined at the PCI Express node itself.

In an embodiment, gateway controller 112 can query each PCI Express node in computer network 100 to communicate its local PCI Express address map. For example, gateway controller 112 can determine if a node in computer network 100 is a PCI Express node. If it is, then gateway controller 112 can request that the PCI Express node communicate its local PCI Express address map. For example, gateway controller 112 can query PCI Express node 102 to communicate local PCI Express address map 114 to gateway controller 112. Also, PCI Express node 104 can be queried and send local PCI Express address map 116 to gateway controller 112.

In another embodiment, local PCI Express address map 114, 116 can comprise global PCI Express addresses for each of PCI Express computing elements 130, 132. While each local PCI Express address map lists PCI Express computing elements 130, 132 local to a particular PCI Express node 102, 104, the addresses in the local PCI Express address map can be global PCI Express addresses 119.

In another embodiment, each PCI Express node 102, 104 can build a translation table (to be discussed more fully below) that can be for example, a look-up table, to translate local PCI Express addresses 117 to global PCI Express addresses 119 and vice versa for incoming and outgoing packets respectively.

Upon receipt of all local PCI Express address maps from PCI Express nodes in computer network 100, gateway controller 112 can build an IP-to-PCI Express address map 122. In an embodiment, gateway controller 112 can use each of the local PCI Express address maps 114, 116 to assign a global PCI Express address to each PCI Express computing element 130, 132 in computer network 100. In this embodiment the translation table mentioned above would have to be communicated to each respective PCI Express node 102, 104. In another embodiment, the translation table could be built at each PCI Express node respectively. In yet another embodiment, each local PCI Express address map 114, 116 can include global PCI Express addresses for each of the PCI Express computing elements 130, 132.

In an embodiment, each of the global PCI Express addresses assigned to each of the PCI Express computing elements 130, 132 is unique. Each global PCI Express address 119 corresponds to one of the PCI Express computing elements 130, 132 in computer network 100. In an embodiment, IP-to-PCI Express map 122 can be a look-up table, database, list, and the like.

In an embodiment IP-to-PCI Express map 122 corresponds each global PCI Express address 119 to an IP address 118, 120 where the PCI Express computing element 130, 132 resides. For example, IP-to-PCI Express map 122 can match IP address 118 for PCI Express node 102 to the global PCI Express address 119 for each PCI Express computing element 130 on PCI Express node 102. Also, IP-to-PCI Express map 122 can match IP address 120 for PCI Express node 104 to the global PCI Express address 119 for each PCI Express computing element 132 on PCI Express node 104. In an embodiment, IP-to-PCI Express map 122 can correlate an IP address of a PCI Express node to a global PCI Express address and memory size for that PCI Express node.

In an embodiment, after gateway controller 112 builds IP-to-PCI Express map 122, gateway controller 112 can communicate IP-to-PCI Express map 122 to each PCI Express node 102, 104 in computer network 100. For example, gateway controller 112 can communicate IP-to-PCI Express map 122 to PCI Express-to-IP bridge 103 on PCI Express node 102, and to PCI Express-to-IP bridge 105 on PCI Express node 104.

The invention is not limited to computer networks having only PCI Express nodes. Computer network 100 can include other nodes coupled to IP packet network 110 that function using another protocol besides PCI Express.

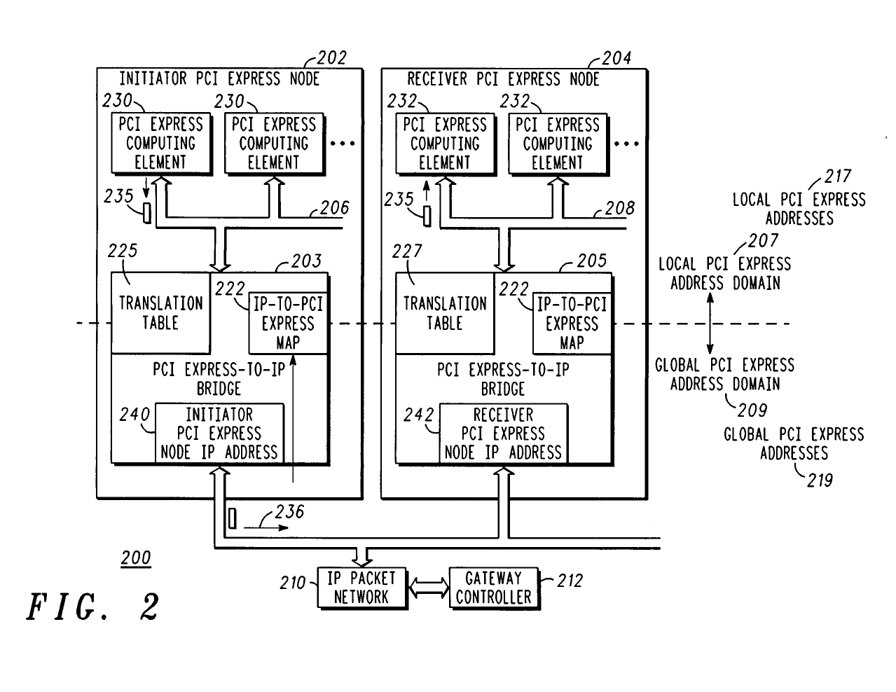

FIG. 2 depicts a computer network 200 according to another embodiment of the invention. In an embodiment, the computer network 200 of FIG. 2 depicts a method of transporting a PCI Express packet 235 from an initiator PCI Express node 202 to a receiver PCI Express node 204 over an IP packet network 210. Computer network 200 can include local PCI Express address domain 207 with local PCI Express addresses 217, and global PCI Express address domain 209 with global PCI Express addresses 219 as discussed above with reference to FIG. 1.

As shown in FIG. 2, computer network 200 can include IP packet network 210 coupled to initiator PCI Express node 202 and receiver PCI Express node 204. Initiator PCI Express node 202 can include one or more PCI Express computing elements 230. PCI Express computing element 230 can include, but is not limited to, a processor, memory device, storage device, communication device providing wireline or wireless access, and the like. PCI Express computing element 230 is coupled to communicate on PCI Express network 206 using PCI Express packet 235. In an embodiment, PCI Express packet 235 can be a Transaction Layer Packet (TLP) datagram formatted to be communicated over PCI Express network 206.

PCI Express network 206 is coupled to PCI Express-to-IP bridge 203, which is coupled to encapsulate a PCI Express packet 235 into an IP packet 236 for transport over IP packet network 210. PCI Express-to-IP bridge 203 can also function to de-encapsulate a PCI Express packet 235 from an IP packet 236 so the PCI Express packet 235 can be communicated over PCI Express network 206.

Receiver PCI Express node 204 can include one or more PCI Express computing elements 232. PCI Express computing element 232 is coupled to communicate on PCI Express network 208 using PCI Express packet 235. In an embodiment, PCI Express packet 235 can be a Transaction Layer Packet (TLP) datagram formatted to be communicated over PCI Express network 208. PCI Express network 208 is coupled to PCI Express-to-IP bridge 205, which is coupled to encapsulate a PCI Express packet 235 into an IP packet 236 for transport over IP packet network 210. PCI Express-to-IP bridge 205 can also function to de-encapsulate a PCI Express packet 235 from an IP packet 236 so the PCI Express packet 235 can be communicated over PCI Express network 208.

As described with reference to FIG. 1, an initiator PCI Express node IP address 240 can be communicated to initiator PCI Express node 202 from gateway controller 212 or otherwise statically determined. Also, receiver PCI Express node IP address 242 can be communicated to receiver PCI Express node 204 from gateway controller 212 or otherwise statically determined. Further, as described with reference to FIG. 1, IP-to-PCI Express map 222 can be determined and communicated to both initiator PCI Express node 202 and receiver PCI Express node 204.

In an embodiment, PCI Express computing element 230 at initiator PCI Express node 202 can create PCI Express packet 235. In an embodiment, PCI Express packet 235 can include a global PCI Express destination address 219 that is unique such that PCI Express packet 235 is addressed to one of PCI Express computing elements 232 on receiver PCI Express node 204. In this embodiment, PCI Express packet 235 is required to traverse IP packet network 210 as shown in FIG. 2.

PCI Express packet 235 can be communicated over PCI Express network 206 at initiator PCI Express node 202 to PCI Express-to-IP bridge 203, where the global PCI Express destination address is read. In an embodiment, PCI Express-to-IP bridge 203 can use IP-to-PCI Express map 222 to map global PCI Express destination address 219 to receiver PCI Express node IP address 242. In an embodiment, receiver PCI Express node IP address 242 can be included in a header of the IP packet 236. In a further embodiment, PCI Express-to-IP bridge 203 of initiator PCI Express node 202 can examine PCI Express packet 235 to determine at least one of a format or a version of PCI Express that is being used so as to include this in the IP packet 236. In accordance with mapping, PCI Express packet 235 can be encapsulated in an IP packet 236, where IP packet 236 is communicated to receiver PCI Express node 204 over IP packet network 210.

In an embodiment, upon receipt of IP packet 236 at receiver PCI Express node 204, PCI Express-to-IP bridge 205 can de-encapsulate PCI Express packet 235 from IP packet 236. Thereafter, PCI Express packet 235 can be issued via PCI Express network 208 to PCI Express computing element 232 corresponding to the global PCI Express destination address 219.

In an embodiment, PCI Express computing element 230 at initiator PCI Express node 202 can create PCI Express packet 235. In an embodiment, PCI Express packet 235 can include a local PCI Express destination address such that PCI Express packet 235 is addressed to one of PCI Express computing elements 232 on receiver PCI Express node 204. In this embodiment, PCI Express packet 235 is required to traverse IP packet network 210 as shown in FIG. 2.

PCI Express packet 235 can be communicated over PCI Express network 206 at initiator PCI Express node 202 to PCI Express-to-IP bridge 203. PCI Express-to-IP bridge 203 can use translation table 225 to translate local PCI Express destination address to a global PCI Express destination address that uniquely corresponds to PCI Express computing element 232 where the PCI Express packet is destined. Translation table 225 can be acquired from gateway controller 212 at initialization of computer network 200 or can be derived by initiator PCI Express node 202. Both translation tables 225, 227 can function to provide mapping of local PCI Express destination addresses to global PCI Express destination addresses and vice versa.

In an embodiment, PCI Express-to-IP bridge 203 can use IP-to-PCI Express map 222 to map global PCI Express destination address to receiver PCI Express node IP address 242. In an embodiment, receiver PCI Express node IP address 242 can be included in a header of the IP packet 236. In a further embodiment, PCI Express-to-IP bridge 203 of initiator PCI Express node 202 can examine PCI Express packet 235 to determine at least one of a format or a version of PCI Express that is being used so as to include this in the IP packet 236. In accordance with mapping, PCI Express packet 235 can be encapsulated in an IP packet 236, where IP packet 236 is communicated to receiver PCI Express node 204 over IP packet network 210.

In an embodiment, upon receipt of IP packet 236 at receiver PCI Express node 204, PCI Express-to-IP bridge 205 can de-encapsulate PCI Express packet 235 from IP packet 236. The global PCI Express destination address of PCI Express packet 235 can be translated back to local PCI Express destination address using translation table 227. Thereafter, PCI Express packet 235 can be issued via PCI Express network 208 to PCI Express computing element 232 corresponding to the local PCI Express destination address.

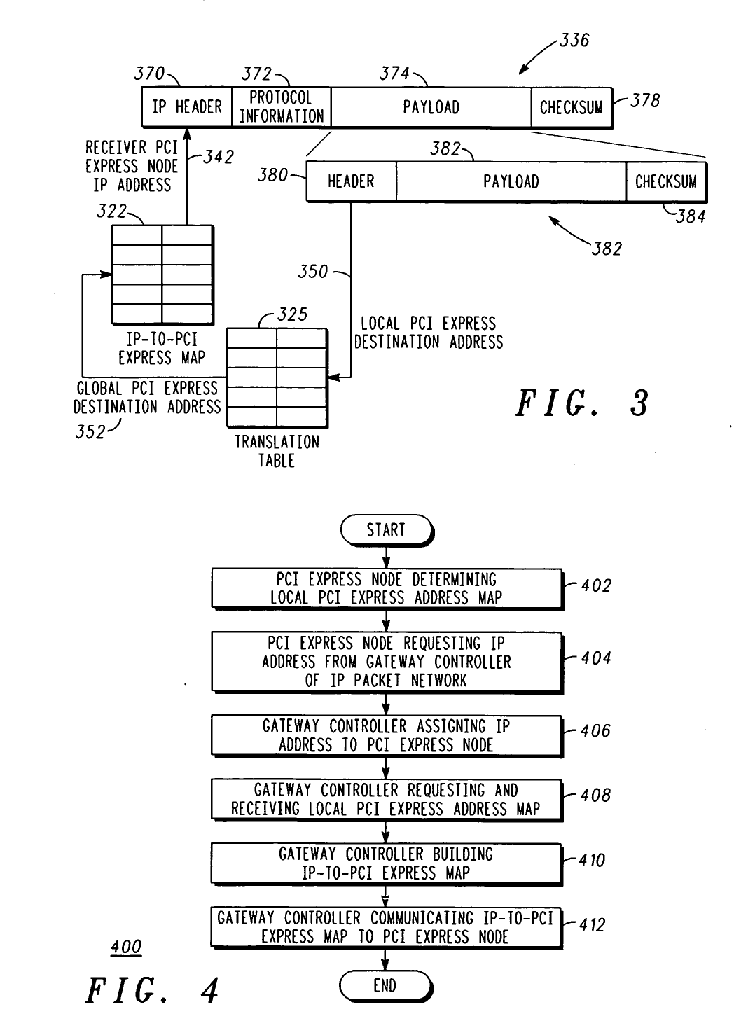

FIG. 3 depicts a PCI Express packet 335 encapsulated into an IP packet 336 according to an embodiment of the invention. In general, individual fields of an IP packet 336 are known in the art. The IP header 370 can include things such as the destination IP address, source address, version, flags, length, and the like. Protocol information 372 can include the protocol used in the payload field 374 including what upper layer protocol is to receive incoming packets after IP processing. Checksum 378 can ensure packet integrity.

PCI Express packet 335 can include header field 380, which can include either local PCI Express destination address or global PCI Express destination address. Payload 382 can include the data being transported by PCI Express packet 335. Checksum 384 ensures PCI Express packet integrity.

In an embodiment, PCI Express packet 335 can be created by a PCI Express computing element in an initiator PCI Express node as described above. In one embodiment, PCI Express packet 335 can include a local PCI Express destination address 350 in header 380. In this embodiment, PCI Express-to-IP bridge can include a translation table 325 that can be used to translate local PCI Express destination address 350 to global PCI Express destination address 352 as described above. In another embodiment, header 380 can include global PCI Express destination address 352, thereby eliminating the need for translation table 325.

In either of the above embodiments, PCI Express-to-IP bridge can include IP-to-PCI Express map 322 to map global PCI Express destination address 352 to receiver PCI Express node IP address 342. In an embodiment, receiver PCI Express node IP address 342 is placed in IP header 370 such that IP packet 336 is addressed to receiver PCI Express node corresponding with global PCI Express destination address 352. In other words, IP packet 336 is addressed to receiver PCI Express node having PCI express computing element to which PCI Express packet 335 is destined. PCI Express packet 335 can then be encapsulated in payload portion 374 of IP packet 336 as shown in FIG. 3.

When IP packet 336 arrives at receiver PCI Express node, the reverse of the above process can occur. For example, PCI Express-to-IP bridge at receiver PCI Express node can use IP-to-PCI Express map 322 to de-encapsulate PCI Express packet 335 and translate receiver PCI Express node IP address 342 back to global PCI Express destination address 352. Then, if required, translation table 325 can be used to translate global PCI Express destination address back to local PCI Express destination address. Thereafter, PCI Express packet 335 can be communicated over PCI Express network to PCI Express computing element.

FIG. 4 illustrates a flow diagram 400 of a method of the invention according to an embodiment of the invention. In an embodiment, FIG. 4 sets forth a method of initializing a computer network. In step 402, a PCI Express node determines a local PCI Express address map for the PCI Express computing elements at PCI Express node. In step 404, PCI Express node requests an IP address from gateway controller of an IP packet network. In step 406, gateway controller issues an IP address to PCI Express node. Optionally, steps 404 and 406 can be replaced with the step of the PCI Express node generating its own static IP address or receiving an IP address from another source.

In step 408, gateway controller can request and receive local PCI Express address map from PCI Express node. Gateway controller can first determine if a node coupled to IP packet network is a PCI Express node before requesting local PCI Express address map.

In step 410, gateway controller can build an IP-to-PCI Express map using a plurality of global PCI Express addresses and local PCI Express address map. In step 412, gateway controller can communicate IP-to-PCI Express map to PCI Express node. The above steps illustrated in FIG. 4 can occur for any number of PCI Express nodes coupled to IP packet network.

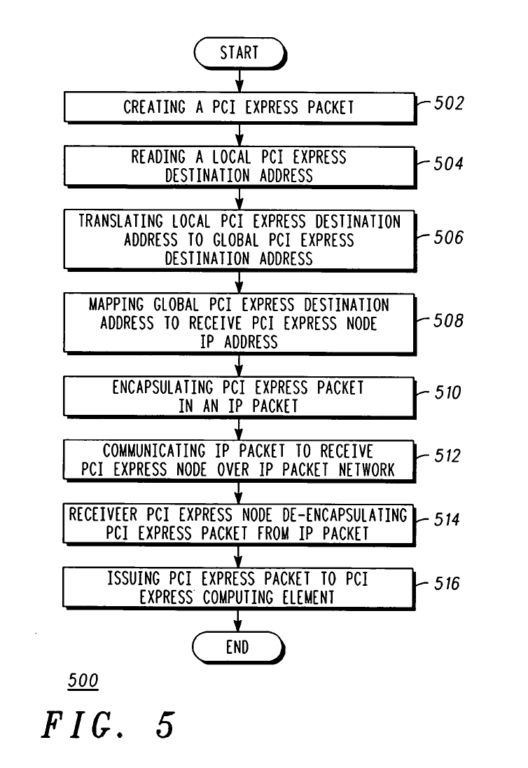

FIG. 5 illustrates a flow diagram 500 of a method of the invention according to another embodiment of the invention. In an embodiment, FIG. 5 sets forth a method of transporting a PCI Express packet from an initiator PCI Express node, over an IP packet network, to a receiver PCI Express node. In step 502, a PCI Express packet is created by a PCI Express computing element at initiator PCI Express node. In step 504, a PCI Express-to-IP bridge can read local PCI Express destination address from PCI Express packet. Optionally, PCI Express-to-IP bridge can read global PCI Express destination address from PCI Express packet.

In step 506, if PCI Express packet includes local PCI Express destination address, then the local PCI Express destination address can be translated to a global PCI Express destination address. In step 508, IP-to-PCI Express map at initiator PCI Express node can be used to map global PCI Express destination address to a receiver PCI Express node IP address. In step 510, PCI Express packet can be encapsulated in an IP packet. In step 512, IP packet can be communicated over IP packet network to receiver PCI Express node. In step 514, PCI Express packet can be de-encapsulated from IP packet at PCI Express-to-IP bridge at receiver PCI Express node. In step 516, PCI Express packet can be issued to a PCI Express computing element over a PCI Express network on receiver PCI Express node.

While we have shown and described specific embodiments of the present invention, further modifications and improvements will occur to those skilled in the art. It is therefore, to be understood that appended claims are intended to cover all such modifications and changes as fall within the true spirit and scope of the invention.

1. In a computer network, a method of transporting a PCI Express packet from an initiator PCI Express node over an IP packet network to a receiver PCI Express node, comprising:
the initiator PCI Express node creating the PCI Express packet;
reading a local PCI Express destination address of the PCI Express packet;
translating the local PCI Express destination address to a global PCI Express destination address;
mapping the global PCI Express destination address to a receiver PCI Express node IP address;
encapsulating the PCI Express packet in an IP packet; and
communicating the IP packet to the receiver PCI Express node over the IP packet network.

2. The method of claim 1, further comprising:
the receiver PCI Express node de-encapsulating the PCI Express packet from the IP packet;
translating the global PCI Express destination address to the local PCI Express destination address; and
issuing the PCI Express packet to a PCI Express computing element having the local PCI Express destination address.

3. The method of claim 1, further comprising the initiator PCI Express node examining the PCI Express packet to determine at least one of a format and a version of the PCI Express packet.

4. The method of claim 1, further comprising placing the receiver PCI Express node IP address into an IP header of the IP packet.

5. In a computer network, a method of transporting a PCI Express packet from an initiator PCI Express node over an IP packet network to a receiver PCI Express node, comprising:
the initiator PCI Express node creating the PCI Express packet;
reading a global PCI Express destination address of the PCI Express packet;
mapping the global PCI Express destination address to a receiver PCI Express node IP address;
encapsulating the PCI Express packet in an IP packet; and
communicating the IP packet to the receiver PCI Express node over the IP packet network.

6. The method of claim 5, further comprising:
the receiver PCI Express node de-encapsulating the PCI Express packet from the IP packet; and
issuing the PCI Express packet to a PCI Express computing element having the global PCI Express destination address.

7. The method of claim 5, further comprising the initiator PCI Express node examining the PCI Express packet to determine at least one of a format and a version of the PCI Express packet.

8. The method of claim 5, further comprising placing the receiver PCI Express node IP address into an IP header of the IP packet.

9. A method of initializing a computer network, comprising:
a PCI Express node coupled to an IP packet network determining a local PCI Express address map;
the PCI Express node requesting an IP address from a gateway controller of the IP packet network;
the gateway controller assigning the IP address to the PCI Express node;
the gateway controller building an IP-to-PCI Express map using a plurality of global PCI Express addresses based on the local PCI Express address map; and
the gateway controller communicating the IP-to-PCI Express map to the PCI Express node.

10. The method of claim 9, further comprising:
the gateway controller determining the PCI Express node; and
if the gateway controller determines the PCI Express node, the gateway controller requesting the local PCI Express address map in order to build the IP-to-PCI Express map.

11. The method of claim 9, wherein the PCI Express node functions as an initiator PCI Express node, the method further comprising:
the initiator PCI Express node creating a PCI Express packet addressed to one of the plurality of global PCI Express destination addresses;
mapping the one of the plurality of global PCI Express destination addresses to a receiver PCI Express node IP address;
encapsulating the PCI Express packet in an IP packet; and
communicating the IP packet to a receiver PCI Express node over the IP packet network.

12. A method of initializing a computer network, comprising:
a plurality of PCI Express nodes coupled to an IP packet network each determining one of a plurality of local PCI Express address maps;
each of the plurality of PCI Express nodes requesting an IP address from a gateway controller of the IP packet network;
the gateway controller assigning the IP address to each of the plurality of PCI Express nodes;
the gateway controller building an IP-to-PCI Express map using a plurality of global PCI Express addresses and the plurality of local PCI Express address maps corresponding to each the plurality of PCI Express nodes; and
the gateway controller communicating IP-to-PCI Express map to the plurality of PCI Express nodes.

13. The method of claim 12, wherein one of the plurality of PCI Express nodes functions as an initiator PCI Express node and one of the plurality of PCI Express nodes functions as a receiver PCI Express node the method further comprising:
the initiator PCI Express node creating a PCI Express packet addressed to one of the plurality of global PCI Express destination addresses at the receiver PCI Express node;
mapping the one of the plurality of global PCI Express destination addresses to a receiver PCI Express node IP address;
encapsulating the PCI Express packet in an IP packet; and
communicating the IP packet to the receiver PCI Express node over the IP packet network.

14. A PCI Express node, comprising:
a PCI Express network having at least one PCI Express computing element; and
a PCI Express-to-IP bridge coupled to the PCI Express network, wherein the PCI Express-to-IP bridge couples the PCI Express node to an IP packet network, wherein the PCI Express-to-IP bridge is coupled to determine a local PCI Express address map of the PCI Express network, wherein the PCI Express-to-IP bridge is coupled to request an IP address from a gateway controller of the IP packet network, wherein the PCI Express-to-IP bridge is coupled to map a global PCI Express destination address to a receiver PCI Express node IP address, and wherein the PCI Express-to-IP bridge is coupled to encapsulate a PCI Express packet generated from the PCI Express network into an IP packet.

15. The PCI Express node of claim 14, wherein the PCI Express-to-IP bridge is coupled to communicate the IP packet to a receiver PCI Express node over the IP packet network.

16. In a PCI Express node, a method of communicating a PCI Express packet over an IP packet network, comprising:
creating the PCI Express packet;
reading a local PCI Express destination address of the PCI Express packet;
translating the local PCI Express destination address to a global PCI Express destination address;
mapping the global PCI Express destination address to a receiver PCI Express node IP address;
encapsulating the PCI Express packet in an IP packet; and
communicating the IP packet to a receiver PCI Express node over the IP packet network.

17. The PCI Express node of claim 16, further comprising examining the PCI Express packet to determine at least one of a format and a version of the PCI Express packet.

18. The PCI Express node of claim 16, further comprising placing the receiver PCI Express node IP address into an IP header of the IP packet.

19. In a PCI Express node, a method of communicating a PCI Express packet over an IP packet network, comprising:
receiving an IP packet over the IP packet network, wherein the IP packet comprises the PCI Express packet;
de-encapsulating the PCI Express packet from the IP packet; and
issuing the PCI Express packet to a PCI Express computing element having a local PCI Express destination address.

20. In a PCI Express node, a method of initializing an IP packet network, comprising:
determining a local PCI Express address map;
requesting and receiving an IP address from a gateway controller of the IP packet network;
communicating the local PCI Express address map to the gateway controller;
the gateway controller building an IP-to-PCI Express map using a plurality of global PCI Express addresses based on the local PCI Express address map; and
the gateway controller communicating the IP-to-PCI Express map to the PCI Express node.

21. A computer-readable medium containing computer instructions for instructing a processor to perform a method of transporting a PCI Express packet from an initiator PCI Express node over an IP packet network to a receiver PCI Express node, the instructions comprising:
the initiator PCI Express node creating the PCI Express packet;
reading a local PCI Express destination address of the PCI Express packet;
translating the local PCI Express destination address to a global PCI Express destination address;
mapping the global PCI Express destination address to a receiver PCI Express node IP address;
encapsulating the PCI Express packet in an IP packet; and
communicating the IP packet to the receiver PCI Express node over the IP packet network.

22. The computer-readable medium of claim 21, further comprising:
the receiver PCI Express node de-encapsulating the PCI Express packet from the IP packet;
translating the global PCI Express destination address to the local PCI Express destination address; and
issuing the PCI Express packet to a PCI Express computing element having the local PCI Express destination address.

23. The computer-readable medium of claim 21, further comprising the initiator PCI Express node examining the PCI Express packet to determine at least one of a format and a version of the PCI Express packet.

24. The computer-readable medium of claim 21, further comprising placing the receiver PCI Express node IP address into an IP header of the IP packet.

25. A computer-readable medium containing computer instructions for instructing a processor to perform a method of transporting a PCI Express packet from an initiator PCI Express node over an IP packet network to a receiver PCI Express node, the instructions comprising:
the initiator PCI Express node creating the PCI Express packet;
reading a global PCI Express destination address of the PCI Express packet;
mapping the global PCI Express destination address to a receiver PCI Express node. IP address;
encapsulating the PCI Express packet in an IP packet; and
communicating the IP packet to the receiver PCI Express node over the IP packet network.

26. The computer-readable medium of claim 25, further comprising:
the receiver PCI Express node de-encapsulating the PCI Express packet from the IP packet; and
issuing the PCI Express packet to a PCI Express computing element having the global PCI Express destination address.

27. A computer-readable medium containing computer instructions for instructing a processor to perform a method of initializing a computer network, the instructions comprising:
a PCI Express node coupled to an IP packet network determining a local PCI Express address map;
the PCI Express node requesting an IP address from a gateway controller of the IP packet network;
the gateway controller assigning the IP address to the PCI Express node;
the gateway controller building an IP-to-PCI Express map using a plurality of global PCI Express addresses based on the local PCI Express address map; and
the gateway controller communicating the IP-to-PCI Express map to the PCI Express node.

28. The computer-readable medium of claim 27, further comprising:
the gateway controller determining the PCI Express node; and
if the gateway controller determines the PCI Express node, the gateway controller requesting the local PCI Express address map in order to build the IP-to-PCI Express map.

29. The computer-readable medium of claim 27, wherein the PCI Express node functions as an initiator PCI Express node, the computer-readable medium instructions further comprising:
the initiator PCI Express node creating a PCI Express packet addressed to one of the plurality of global PCI Express destination addresses;
mapping the one of the plurality of global PCI Express destination addresses to a receiver PCI Express node IP address;
encapsulating the PCI Express packet in an IP packet; and
communicating the IP packet to a receiver PCI Express node over the IP packet network.

30. A computer-readable medium containing computer instructions for instructing a processor to perform a method of initializing a computer network, the instructions comprising:
a plurality of PCI Express nodes coupled to an IP packet network each determining one of a plurality of local PCI Express address maps;
each of the plurality of PCI Express nodes requesting an IP address from a gateway controller of the IP packet network;
the gateway controller assigning the IP address to each of the plurality of PCI Express nodes;
the gateway controller building an IP-to-PCI Express map using a plurality of global PCI Express addresses and the plurality of local PCI Express address maps corresponding to each the plurality of PCI Express nodes; and
the gateway controller communicating IP-to-PCI Express map to the plurality of PCI Express nodes.

31. The computer-readable medium of claim 30, wherein one of the plurality of PCI Express nodes functions as an initiator PCI Express node and one of the plurality of PCI Express nodes functions as a receiver PCI Express node, the method further comprising:
the initiator PCI Express node creating a PCI Express packet addressed to one of the plurality of global PCI Express destination addresses at the receiver PCI Express node;
mapping the one of the plurality of global PCI Express destination addresses to a receiver PCI Express node IP address;
encapsulating the PCI Express packet in an IP packet; and
communicating the IP packet to the receiver PCI Express node over the IP packet network.

32. In a PCI Express node, a computer-readable medium containing computer instructions for instructing a processor to perform a method of communicating a PCI Express packet over an IP packet network, comprising:
creating the PCI Express packet;
reading a local PCI Express destination address of the PCI Express packet;
translating the local PCI Express destination address to a global PCI Express destination address;
mapping the global PCI Express destination address to a receiver PCI Express node IP address;
encapsulating the PCI Express packet in an IP packet; and
communicating the IP packet to the receiver PCI Express node over the IP packet network.

33. In a PCI Express node, a computer-readable medium containing computer instructions for instructing a processor to perform a method of communicating a PCI Express packet over an IP packet network, comprising:
receiving an IP packet over the IP packet network, wherein the IP packet comprises the PCI Express packet;
de-encapsulating the PCI Express packet from the IP packet; and
issuing the PCI Express packet to a PCI Express computing element having the local PCI Express destination address.

34. In a PCI Express node, a computer-readable medium containing computer instructions for instructing a processor to perform a method of initializing an IP packet network, comprising:
determining a local PCI Express address map;
requesting and receiving an IP address from a gateway controller of the IP packet network;
communicating the local PCI Express address map to the gateway controller;
the gateway controller building an IP-to-PCI Express map using a plurality of global PCI Express addresses based on the local PCI Express address map; and
the gateway controller communicating the IP-to-PCI Express map to the PCI Express node.
